(19) United States
(12) Patent Application Publication
(10) Pub. No.: US 2016/0208719 A1
(43) Pub. Date: Jul. 21, 2016

(54) CONTROL DEVICE FOR VEHICULAR HYDRAULIC PRESSURE SUPPLY DEVICE

(71) Applicant: AISIN AW CO., LTD., Aichi (JP)

(72) Inventors: Yutaro KAWATSU, Anjo-shi (JP); Mitsuru TAKAHASHI, Anjo-shi (JP); Yoichi TAJIMA, Anjo-shi (JP)

(73) Assignee: AISIN AW CO., LTD., Anjo-shi, Aichi-ken (JP)

(21) Appl. No.: 14/912,819

(22) PCT Filed: Sep. 19, 2014
(86) PCT No.: PCT/JP2014/074901

§ 371 Date: Feb. 18, 2016

(30) Foreign Application Priority Data
Sep. 30, 2013 (JP) 2013-204928

(51) Int. Cl. F02D 29/04

(52) U.S. Cl. CPC F02D 29/04

(57) ABSTRACT

A control device for a vehicular hydraulic pressure supply device that controls the vehicular hydraulic pressure supply device provided with a mechanical oil pump that is driven by an internal combustion engine, an electric oil pump that is driven by an electric motor, and an oil passage that supplies oil discharged from the mechanical oil pump and the electric oil pump to a supply target.

### BACKGROUND

The present disclosure relates to a control device that controls a vehicular hydraulic pressure supply device provided with a mechanical oil pump that is driven by an internal combustion engine, an electric oil pump that is driven by an electric motor, an oil passage that supplies oil discharged from the mechanical oil pump and the electric oil pump to a supply target.

A device described in Japanese Patent Application Publication No. 2006-258033 described below is already known as an example of the control device for the vehicular hydraulic pressure supply device as described above. The technology described in Japanese Patent Application Publication No. 2006-258033 discloses a device that is configured to, in a case in which an idle running state in which air is mixed in a pump chamber accommodating a pump rotor of an electric oil pump, etc. is caused and a rotational speed of an electric motor becomes equal to or greater than a predetermined rotational speed, in order to suppress occurrence of wearing and failure of the electric pump due to over-rotation of the electric motor, repeat a restart-up process that restarts driving of the electric motor after stopping the driving of the electric motor for a predetermined period of time until the idle running state is solved.

### SUMMARY

However, in the technique of Japanese Patent Application Publication No. 2006-258033, in a case in which the idle running state is caused, the driving of the electric motor is temporarily stopped. Therefore, elimination of air is delayed. Thereby, it may take time to solve the idle running state, and a start of oil supply by the electric oil pump may be delayed.

In addition, Japanese Patent Application Publication No. 2006-258033 does not disclose a method to supplement a shortage of oil supply before the idle running state of the electric oil pump is solved.

Therefore, control devices for vehicular hydraulic pressure supply devices are desired, which are capable of supplementing a shortage of oil supply and promptly solving an idle running state in a case in which the idle running state is caused in the electric oil pump.

A control device according to an exemplary aspect of the present disclosure that controls the vehicular hydraulic pressure supply device provided with a mechanical oil pump that is driven by an internal combustion engine, an electric oil pump that is driven by an electric motor, and an oil passage that supplies oil discharged from the mechanical oil pump and the electric oil pump to a supply target, includes a controller that is configured to execute electromotive drive control that causes the electric oil pump to be driven while rotation of the internal combustion engine is stopped, wherein during execution of the electromotive drive control, in a case in which a rotational speed of the electric oil pump becomes greater than a start determination rotational speed, or in a case in which a magnitude of a rate of change in the rotational speed of the electric oil pump becomes greater than a start determination rate of change, the controller starts double pump drive control that starts the rotation of the internal combustion engine to cause the mechanical oil pump to be driven and continues driving of the electric oil pump.

Even in a case in which the rotation of the internal combustion engine is stopped and the driving of the mechanical oil pump is stopped, it may be necessary to cause the electric oil pump to be driven and supply oil to a supply target. For example, for an idling-stop vehicle, in order to enable the vehicle to start immediately after starting the internal combustion engine even during idling-stop in which the rotation of the internal combustion engine is stopped, it is preferable to cause the electric oil pump to be driven, supply oil to a speed change device, and establish a shift speed. Alternatively, for a hybrid vehicle provided with an electric motor for driving wheels in addition to the internal combustion engine, in a case in which an electric travel mode in which the rotation of the internal combustion engine is stopped and the wheels are driven by a driving force of the electric motor for driving wheels is executed, it is necessary to cause the electric oil pump to be driven to supply oil to the speed change device and establish a shift speed, and to supply cooling oil to the electric motor for driving wheels.

However, in a case in which the vehicle is on an up/downhill, in a case in which the vehicle speed suddenly changes, etc., a liquid surface of oil stored in an oil pan changes in relation to a horizontal state in which the vehicle is on a horizontal road, thereby the electric oil pump may suck air and an idle running state may be caused. In addition, driving of the electric oil pump is started in a case in which, after the driving of the electric oil pump is stopped for a long period of time, oil is drained from the electric oil pump and its suction oil passage due to influence of gravity, and air is flown in instead. In such a case, the idle running state is caused. In a case in which the idle running state is caused in such a manner, a discharging amount of oil of the electric oil pump decreases, thereby a necessary supply amount of oil may not be ensured.

In a case in which the idle running state is caused, a viscosity resistance of oil acting on a pump rotor decreases. Therefore, the rotational speed of the electric oil pump increases compared to that before the idle running state is caused. In addition, in a case in which the idle running state is caused, the magnitude of the rate of change in the rotational speed of the electric oil pump increases compared to a case in which the idle running state is not caused. According to the aforementioned characteristic configuration, during execution of the electromotive drive control, in a case in which the rotational speed of the electric oil pump becomes greater than the start determination rotational speed, or in a case in which the magnitude of the rate of change in the rotational speed of the electric oil pump becomes greater than the start determination rate of change, the rotation of the internal combustion engine is started and the mechanical oil pump is driven. Therefore, the shortage of the supply amount of oil caused by the occurrence of the idle running state may be reduced or solved. In addition, the driving of the electric oil pump continues after the driving of the mechanical oil pump is started. Therefore, it is possible to promptly solve the idle running state by discharging air mixed in a pump chamber, etc. and suctioning oil.

Here, it is preferable that the start determination rotational speed is set to a rotational speed that is greater than a target rotational speed of the electric oil pump that performs rotational speed control.

In a case in which the idle running state is caused, the viscosity resistance decreases. Therefore, the rotational speed of the electric oil pump increases with respect to the target rotational speed during the rotational speed control. According to the aforementioned configuration, after the idle running state is caused, it is possible to appropriately start the double pump drive control because of the start determination rotational speed set to be greater than the target rotational speed.

In addition, it is preferable that the start determination rotational speed is set to a rotational speed that is greater than the rotational speed of the electric oil pump when an idle running state is not caused in the electric oil pump, and the start determination rate of change is set to a magnitude of a rate of change that is greater than the magnitude of the rate of change in the rotational speed of the electric oil pump when the idle running state is not caused in the electric oil pump.

In a case in which the idle running state is caused, the viscosity resistance decreases. Therefore, the rotational speed of the electric oil pump increases from the rotational speed when the idle running state is not caused. In addition, in a case in which the viscosity resistance decreases, the magnitude of the rate of change in the rotational speed of the electric oil pump becomes greater than the magnitude of the rate of change when the idle running state is not caused. According to the aforementioned configuration, after the idle running state is caused, it is possible to appropriately start the double pump drive control because of the start determination rotational speed set to a rotational speed that is greater than the rotational speed when the idle running state is not caused and the start determination rate of change set to a magnitude of a rate of change that is greater than the magnitude of the rate of change in the rotational speed when the idle running state is not caused.

Here, it is preferable that, in the electromotive drive control, in a case in which the rate of change in the rotational speed of the electric oil pump during an increase in the rotational speed after the electric oil pump starts to be driven is greater than the start determination rate of change, the controller starts the double pump drive control.

While the driving of the electric oil pump is stopped, air may be mixed in the pump chamber accommodating the pump rotor, etc. and a suction oil passage of the pump chamber due to the aforementioned factors. In a case in which the driving of the electric oil pump is started in a state in which air is mixed in, the viscosity resistance of oil acting on a movable portion such as the pump rotor, etc. decreases. Therefore, the rate of change in the rotational speed of the electric oil pump becomes greater than the rate of change when the idle running state is not caused. According to the aforementioned configuration, after the driving of the electric oil pump is started, when the rotational speed increases, it is possible to promptly determine whether to start the double pump drive control depending on whether the idle running state is caused. Thus, after the driving of the electric oil pump is started, it is possible to promptly start the driving of the mechanical oil pump and promptly reduce or solve the shortage of supply amount of oil.

Here, it is preferable that, during execution of the double pump drive control, in a case in which a driving force of the electric motor increases to an end determination driving force or more, or in a case in which the magnitude of the rate of change in the rotational speed of the electric oil pump decreases to an end determination rate of change or less, the controller stops the rotation of the internal combustion engine.

When the idle running state in the electric oil pump ends, the discharging amount of oil of the electric oil pump increases. Therefore, it is possible to stop the rotation of the internal combustion engine to stop the driving of the mechanical oil pump. When the rotation of the internal combustion engine is stopped, it is possible to suppress worsening of fuel efficiency caused by the rotation of the internal combustion engine.

In a case in which mixed-in air decreases, the viscosity resistance of oil acting on the movable portion of the pump rotor, etc. increases. Therefore, the driving force of the electric motor increases. According to the aforementioned configuration, in a case in which the driving force of the electric motor increases to the end determination driving force or more due to the end of the idle running state, it is possible to appropriately stop the rotation of the internal combustion engine.

In addition, in a case in which mixed-in air decreases, the viscosity resistance of oil acting on the movable portion of the pump rotor, etc. increases. Therefore, the rotational speed of the electric oil pump is unlikely to change and the magnitude of the rate of change in the rotational speed of the electric oil pump decreases. According to the aforementioned configuration, in a case in which the magnitude of the rate of change in the rotational speed of the electric oil pump decreases to the end determination rate of change or less due to the end of the idle running state, it is possible to appropriately stop the rotation of the internal combustion engine.

Here, it is preferable that the end determination driving force is set to a driving force that is less than a driving force of the electric motor when an idle running state is not caused in the electric oil pump, and the end determination rate of change is set to a magnitude of a rate of change that is greater than the magnitude of the rate of change in the rotational speed of the electric oil pump when the idle running state is not caused in the electric oil pump.

When the idle running state ends, the viscosity resistance increases. Therefore, the driving force of the electric oil pump increases to the driving force when the idle running state is not caused. According to the aforementioned configuration, after the idle running state ends, it is possible to appropriately stop the rotation of the internal combustion engine because of the end determination driving force set to a driving force that is less than the driving force of the electric motor when the idle running state is not caused.

In addition, when the idle running state ends, the viscosity resistance increases. Therefore, the magnitude of the rate of change in the rotational speed of the electric oil pump becomes less than the magnitude of the rate of change in the rotational speed of the electric oil pump when the idle running state is not caused. According to the aforementioned configuration, after the idle running state ends, it is possible to appropriately stop the rotation of the internal combustion engine because of the end determination rate of change that is set to a magnitude of a rate of change that is greater than the magnitude of the rate of change in the rotational speed of the electric oil pump when the idle running state is not caused.

Here, it is preferable that, during execution of the electromotive drive control, in a case in which a driving force of the electric motor decreases to a start determination driving force or less, the controller starts the double pump drive control.

In a case in which air is mixed in while the electric oil pump is driven, the viscosity resistance of oil acting on the movable portion such as the pump rotor, etc. decreases. Therefore, the driving force of the electric motor decreases. According to the aforementioned configuration, during the execution of the electromotive drive control, in a case in which the driving force of the electric motor decreases to the start determination driving force or less due to the occurrence of the idle running state, it is possible to appropriately start the double pump drive control.

### BRIEF DESCRIPTION OF THE DRAWINGS

FIG. 1 is a schematic view that shows configuration of a vehicular hydraulic pressure supply device and a control device according to an embodiment of the present disclosure.

FIG. 2 is a block diagram that shows configuration of an electric motor control section and a rotational speed control section according to the embodiment of the present disclosure.

FIG. 3 is a timing chart showing a behavior of electromotive drive control according to the embodiment of the present disclosure.

FIG. 4 is a timing chart showing a behavior of the electromotive drive control according to the embodiment of the present disclosure.

FIG. 5 is a flowchart showing a process of the electromotive drive control according to the embodiment of the present disclosure.

### DETAILED DESCRIPTION OF EMBODIMENTS

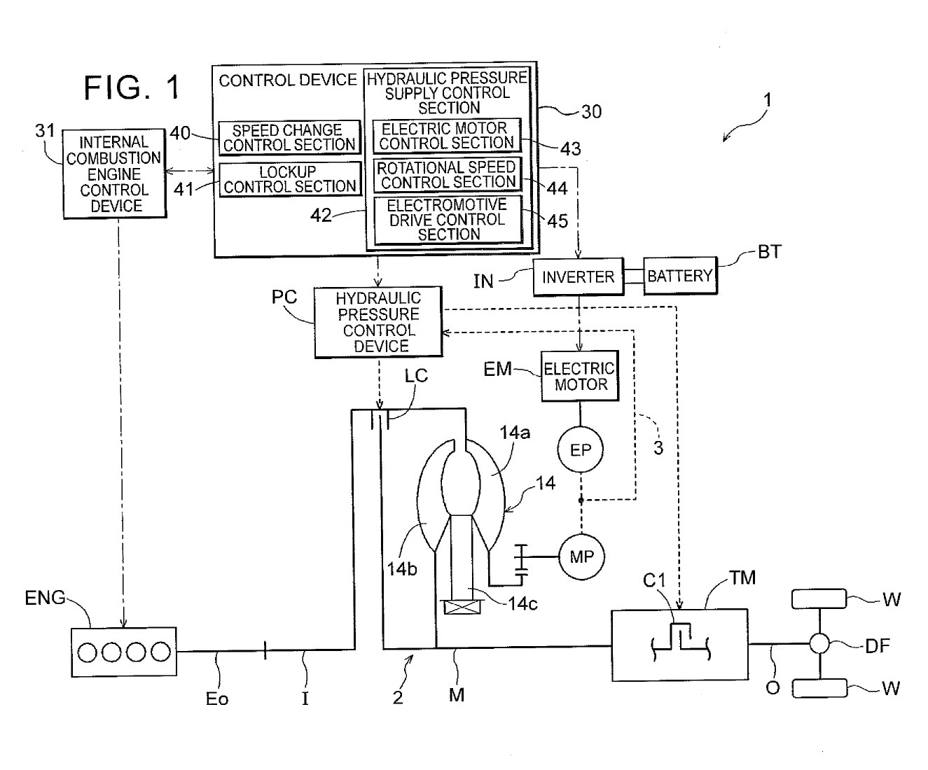

A control device 30 for a vehicular hydraulic pressure supply device 1 (hereinafter, simply referred to as control device 30) according to the present disclosure is explained with reference to drawings. FIG. 1 is a schematic view that shows schematic configuration of the vehicular hydraulic pressure supply device 1 and the control device 30 according to an embodiment. In this figure, a solid line indicates a transmission path of a driving force, a dashed line indicates a supply path of oil, and a dashed dotted line indicates a transmission path of signals. The vehicular hydraulic pressure supply device 1 is provided with a mechanical oil pump MP driven by an internal combustion engine ENG, an electric oil pump EP driven by an electric motor EM, and an oil passage 3 that supplies oil discharged from the mechanical oil pump MP and the electric oil pump EP to a supply target.

In the present embodiment, the vehicular hydraulic pressure supply device 1 is installed in a vehicle and constitutes a part of a vehicular drive device 2.

The control device 30 is provided with an electromotive drive control section 45 that executes electromotive drive control that causes the electric oil pump EP to be driven while rotation of the internal combustion engine ENG is stopped.

The electromotive drive control section 45 is configured to, during execution of the electromotive drive control, in a case in which a rotational speed ωm of the electric oil pump EP becomes greater than a start determination rotational speed, or in a case in which a magnitude of a rate of change in the rotational speed ωm of the electric oil pump EP becomes greater than a start determination rate of change, start double pump drive control that starts the rotation of the internal combustion engine ENG to cause the mechanical oil pump MP to be driven and continues driving of the electric oil pump EP.

Hereinafter, the vehicular hydraulic pressure supply device 1 and the control device 30 according to the present disclosure are explained in detail.

1. Configuration of Vehicular Drive Device 2 and Internal Combustion Engine ENG

The vehicular drive device 2 is drivingly coupled to the internal combustion engine ENG as a driving force source for driving a vehicle and configured to convert a rotational driving force of the internal combustion engine ENG that is inputted from an input shaft I via a torque converter 14 using a speed change device TM and transmits the resultant force to an output shaft O.

The internal combustion engine ENG is a thermal engine driven by combusting fuel. Various kinds of known internal combustion engines, for example, a gasoline engine, a diesel engine, etc. are used as the internal combustion engine ENG. In the present example, an internal combustion engine output shaft Eo, such as a crankshaft, of the internal combustion engine ENG is drivingly coupled to the input shaft I. In addition, the internal combustion engine output shaft Eo is provided with a damper (not shown) and is configured to be capable of damping fluctuations in output torque and rotational speed due to intermittent combustion of the internal combustion engine ENG and transmitting the torque and rotational speed to a wheels' side.

In addition, in the present embodiment, a starter motor is installed adjacent to the internal combustion engine ENG. The starter motor is configured by a direct current motor, etc. and electrically connected to a battery. The starter motor is configured to be capable of being driven by electric power supplied from the battery in a state in which the rotation of the internal combustion engine ENG is stopped, causing the internal combustion engine output shaft Eo to rotate, and starting the internal combustion engine ENG.

The torque converter 14 is provided with a pump impeller 14a serving as an input side rotational member that is coupled to the input shaft I, a turbine runner 14b serving as an output side rotational member that is coupled to a speed change input shaft M, and a stator 14c that is provided therebetween and includes a one-way clutch. The torque converter 14 transmits driving force between the pump impeller 14a on an input side (a driving side) and the turbine runner 14b on an output side (a driven side) through oil filled inside the torque converter 14. The torque converter 14 is provided with a lockup clutch LC as an engagement element for lock-up. The lockup clutch LC is a clutch that couples the pump impeller 14a to the turbine runner 14b so as to rotate together in order to improve transmission efficiency by removing a rotational difference (slip) between the pump impeller 14a and the turbine runner 14b. Oil whose pressure is adjusted by a hydraulic pressure control device PC is supplied to the torque converter 14 including the lockup clutch LC.

The speed change device TM is provided with the speed change input shaft M drivingly coupled to a driving force source side, the output shaft O drivingly coupled to wheels W, and a plurality of engagement devices C1, etc. A plurality of shift speeds are established in accordance with engagement or disengagement of the plurality of engagement devices C1, etc. The speed change device TM shifts the rotational speed of the speed change input shaft M at a speed ratio set for each shift speed and converts the torque thereof, and transmits the resultant rotational speed and torque to the output shaft O. The speed change input shaft M is drivingly coupled to the turbine runner 14b of the torque converter 14. The torque transmitted to the output shaft O through the shift speed from the speed change input shaft M is distributed and transmitted to axle shafts on the right and left sides through an output differential gear device DF, and thereafter transmitted to the wheels W that are drivingly coupled to the respective axle shafts.

2. Schematic Configuration of Vehicular Hydraulic Pressure Supply Device 1

Subsequently, the vehicular hydraulic pressure supply device 1 is explained. The vehicular hydraulic pressure supply device 1 is provided with two kinds of pumps of the mechanical oil pump MP and the electric oil pump EP serving as hydraulic pressure sources that suck oil stored in an oil pan and supply the oil to the supply target of the vehicular drive device 2.

The mechanical oil pump MP is an oil pump that is driven by the rotational driving force of the internal combustion engine ENG and discharges oil. As the mechanical oil pump MP, a gear pump, a vane pump, etc. may be utilized.

In the present embodiment, the mechanical oil pump MP is drivingly coupled to a pump impeller 14a of the torque converter 14 and driven by driving force of the internal combustion engine ENG. However, the mechanical oil pump MP does not discharge oil while the rotation of the internal combustion engine ENG is stopped. Therefore, the electric oil pump EP is provided as a pump to supplement the mechanical oil pump MP.

The electric oil pump EP is an oil pump that is driven by rotational driving force of the electric motor EM and discharges oil. As the electric oil pump EP, a gear pump, a vane pump, etc. may be utilized. The electric motor EM that causes the electric oil pump EP to be driven is electrically connected to an electric storage device BT such as a battery through an inverter IN and receives electric power from the battery to generate a driving force.

In addition, the vehicular hydraulic pressure supply device 1 is provided with the hydraulic pressure control device PC that regulates the hydraulic pressure of oil discharged from the mechanical oil pump MP and the electric oil pump EP to a predetermined pressure and supplies the regulated oil to the supply target. The mechanical oil pump MP and the electric oil pump EP are hydraulic pressure supply sources common to the hydraulic pressure control device PC. The oil discharged from the mechanical oil pump MP and the oil discharged from the electric oil pump EP join together in the oil passage 3, and thereafter, is supplied to a hydraulic pressure control valve of the hydraulic pressure control device PC.

The hydraulic pressure control device PC is provided with a plurality of hydraulic pressure control valves such as a linear solenoid valve to regulate the hydraulic pressure of oil that is supplied from the mechanical oil pump MP and the electric oil pump EP to a predetermined pressure. Each hydraulic pressure control valve regulates an opening degree of the valve in accordance with a signal value in a hydraulic pressure command supplied from the control device 30 to regulate the hydraulic pressure to a predetermined pressure corresponding to the signal value. The oil regulated to the predetermined pressure is supplied to respective supply targets of the vehicular drive device 2 such as a plurality of engagement devices C1, etc. of the speed change device TM, the torque converter 14, the lockup clutch LC, etc.

3. Configuration of Control Device 30

Subsequently, the configuration of the control device 30 that performs control for the vehicular hydraulic pressure supply device 1 and the vehicular drive device 2, and an internal combustion engine control device 31 is explained.

The control device 30 and the internal combustion engine control device 31 each include, as a core member, an arithmetic processing device such as a CPU, etc., and include a storage device such as a RAM (random access memory) configured to be capable of reading and writing data from and into the arithmetic processing device, a ROM (read only memory) configured to be capable of reading data from the arithmetic processing device, etc. Respective function sections 40 to 45, etc. in the control device 30 are configured by software (program) stored in the ROM, etc. in the control device or separately provided hardware such as an arithmetic circuit, or both. The control device 30 and the internal combustion engine control device 31 are configured to communicate with each other, and share various kinds of information such as detected information of sensors and control parameters, etc. and perform cooperative control, to realize the functions of the respective function sections 40 to 45.

3-1. Internal Combustion Engine Control Device 31

The internal combustion engine control device 31 is provided with a function section that performs operation control of the internal combustion engine ENG. The internal combustion engine control device 31 is configured to regulate fuel injection amount, an opening degree of a throttle, etc. based on an extent of opening of the accelerator to control output of the internal combustion engine ENG.

In a case in which an idling stop condition is satisfied, the internal combustion engine control device 31 stops the rotation of the internal combustion engine ENG, for example, by stopping fuel supply. In a case in which the idling stop condition is cancelled and a start condition of the internal combustion engine ENG is satisfied, the internal combustion engine control device 31 supplies electric power to the starter motor, for example, by setting a relay circuit that supplies electric power to the starter motor on, to cause the internal combustion engine ENG to rotate, and starts a fuel supply to the internal combustion engine ENG an ignition of the internal combustion engine ENG, etc. to start the combustion of the internal combustion engine ENG

The idling stop condition is satisfied, for example, in a case in which a shift position is set to a drive range and a braking pedal is depressed, or in a case in which the shift position is set to a neutral range or a parking range, in a state in which an ignition switch (a main electric power source of the vehicular drive device 2) is set on and a vehicle is stopped. On the other hand, the start condition of the internal combustion engine ENG is satisfied when the idling stop condition is canceled, for example, in a case in which the shift position is set to the drive range and the braking pedal is not depressed, or in a case in which the shift position is changed to the drive range from the neutral range or the parking range and the braking pedal is not depressed.

After the ignition switch is set on, in a case in which the idling stop condition is satisfied, the internal combustion engine ENG is configured not to be started until the start condition of the internal combustion engine ENG is satisfied. That is, even after the ignition switch is set on, in a case in which the idling stop condition is satisfied, such as in a case in which the shift position is set to the drive range and the braking pedal is depressed, or in a case in which the shift position is set to the neutral range or the parking range, the internal combustion engine ENG is not started. On the other hand, after the ignition switch is set on, in a case in which the idling stop condition is cancelled and the start condition is satisfied, such as in a case in which the shift position is set to the drive range and the braking pedal is not depressed, or in a case in which the shift position is changed to the drive range from the neutral range or the parking range and the braking pedal is not depressed, the internal combustion engine ENG is started

In a case in which a request to start the rotation of the internal combustion engine ENG by the double pump drive control is transmitted from the electromotive drive control section 45 that is described later in a state in which the rotation of the internal combustion engine ENG is stopped because the idling stop condition is satisfied, etc., the internal combustion engine control device 31 is configured to start the internal combustion engine ENG..

3-2. Control Device 30

The control device 30 is provided with a speed change control section 40 that performs control for the speed change device TM, a lockup control section 41 that performs control for the lockup clutch LC, and a hydraulic pressure supply control section 42 that performs control for the vehicular hydraulic pressure supply device 1.

3-2-1. Speed Change Control Section 40

The speed change control section 40 is a function section that controls the speed change device TM. The speed change control section 40 determines a target shift speed that is established in the speed change device TM based on sensor detected information such as the vehicle speed, the extent of opening of accelerator, the shift position, etc. The speed change control section 40 controls the hydraulic pressure that is supplied to the plurality of engagement devices C1, etc. provided in the speed change device TM through the hydraulic pressure control device PC to engage or disengage the respective engagement devices C1, etc. and establish the target shift speed in the speed change device TM. Specifically, the speed change control section 40 supplies a request for a target hydraulic pressure (request pressure) for the respective engagement devices to the hydraulic pressure control device PC and the hydraulic pressure control device PC supplies the hydraulic pressure of the requested target hydraulic pressure (request pressure) to respective engagement devices. In the present embodiment, the speed change control section 40 is configured to control the hydraulic pressure that is supplied to the respective engagement devices by controlling a signal value that is supplied to the linear solenoid valve provided in the hydraulic pressure control device PC.

The speed change control section 40 performs control that establishes the target shift speed in the speed change device TM to enable the vehicle to start immediately after starting the internal combustion engine ENG while the ignition switch is on even in a case in which the rotation of the internal combustion engine ENG is stopped because the idling stop condition is satisfied, etc. Specifically, in a case in which the idling stop condition is satisfied because the shift position is set to the drive range and the braking pedal is depressed, in order to establish the determined target shift speed (for example, a first speed), the speed change control section 40 is configured to provide a request to the hydraulic pressure control device PC and supply the hydraulic pressure to the engagement devices to establish the target shift speed.

3-2-2. Lockup Control Section 41

The lockup control section 41 is a function section that determines a target engagement state of the lockup clutch LC based on the extent of opening of accelerator, the vehicle speed, and the shift position of the vehicle, and controls engagement or disengagement of the lockup clutch LC. The lockup control section 41 controls the hydraulic pressure that is supplied to the lockup clutch LC through the hydraulic pressure control device PC to engage or disengage the lockup clutch LC. Specifically, the lockup control section 41 supplies a request for a target hydraulic pressure (request pressure) for the lockup clutch LC to the hydraulic pressure control device PC and the hydraulic pressure control device PC supplies the hydraulic pressure of the requested hydraulic pressure (request pressure) to the lockup clutch LC.

The lockup control section 41 is configured to disengage the lockup clutch LC in a case in which the idling stop condition is satisfied.

3-2-3. Hydraulic Pressure Supply Control Section 42

The hydraulic pressure supply control section 42 is a function section that performs control for the vehicular hydraulic pressure supply device 1. The hydraulic pressure supply control section 42 is provided with an electric motor control section 43 that performs drive control for the electric motor EM and the electromotive drive control section 45 that executes electromotive drive control that causes the electric oil pump EP to be driven while the rotation of the internal combustion engine ENG is stopped.

3-2-3-1. Electric Motor Control Section 43

The electric motor control section 43 is a function section that controls a driving force (output torque Tm) of the electric motor EM.

As the electric motor EM, any kinds of electric motors may be utilized as long as they are capable of controlling the output torque. In the present embodiment, a permanent magnet synchronous motor (PMSM) is utilized.

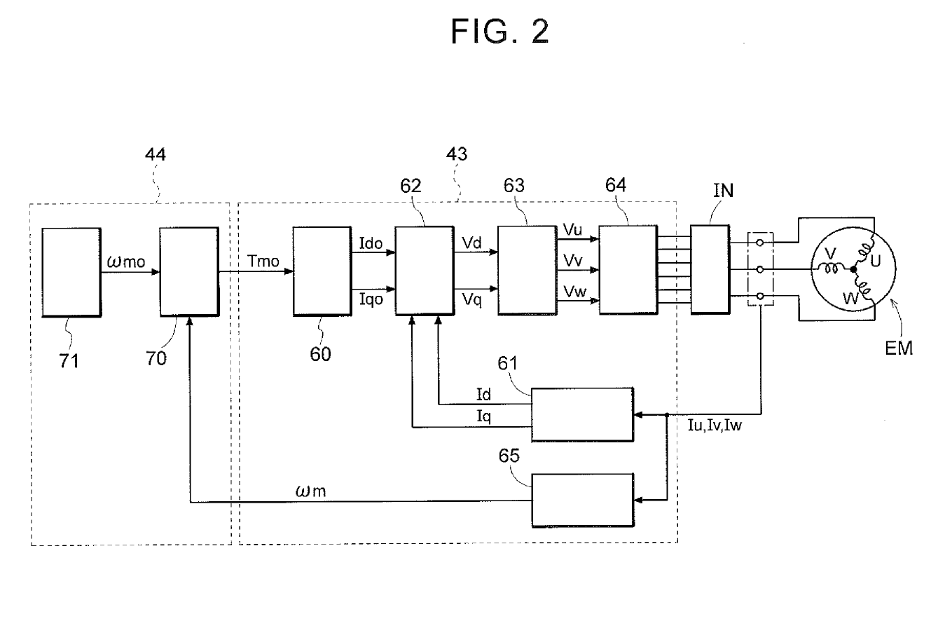

As shown in FIG. 2, the electric motor control section 43 is configured to perform current feedback control using a vector control method with respect to target currents Ido, Iqo.

In vector control, a d axis is set to a direction (magnetic pole position) of N pole of a magnet provided in a motor rotor, a q axis is set to a direction advanced by π/2 in electric angle from the d axis, and a dq axis rotating coordinate system formed of the d axis and the q axis that rotate in synchronization with rotation of the motor rotor in electric angle is set. Here, with reference to a U-phase coil, a lead angle (electric angle) of the d axis (magnetic pole position) is defined as a magnetic pole position θe.

In vector control, the target currents Ido, Iqo are set in the dq axis rotating coordinate system, three-phase currents Iu, Iv, Iw flowing through each phase coil are converted to two-phase currents Id, Iq expressed in the dq axis rotating coordinate system based on the magnetic pole position θe, and current feedback control is executed to control voltages to be applied to the electric motor EM such that the two-phase currents Id, Iq approach the two-phase target currents Ido, Iqo.

In the present embodiment, the electric motor control section 43 is provided with function sections of a target current setting section 60, a current calculating section 61, a current feedback control section 62, an alternate current voltage command calculating section 63, an inverter control section 64, and a position speed calculating section 65.

<Target Current Setting Section 60>

The target electric current setting section 60 sets the two-phase target currents Ido, Iqo that are target currents flowing through the electric motor EM expressed in the dq axis rotating coordinate system. The target current setting section 60 calculates the two-phase target currents Ido, Iqo based on a target output torque Tmo of the electric motor EM calculated by a rotational speed control section 44 that is described later. Specifically, the target current setting section 60 stores relation characteristics between the output torque Tm of the electric motor EM and the two-phase currents Id, Iq and calculates the two-phase target currents Ido, Iqo to achieve the target output torque Tmo using the relation characteristics.

<Current Calculating Section 61>

The current calculating section 61 computes the two-phase currents Id, Iq expressed in the dq axis rotating coordinate system based on the currents Iu, Iv, Iw flowing through the electric motor EM detected by the electric sensor. The current calculating section 61 performs a three-phase to two-phase conversion and a rotating coordinate conversion based on the magnetic pole position θe to convert the three-phase currents Iu, Iv, Iw to d axis current Id and q axis current Iq that are two-phase currents expressed in the dq axis rotating coordinate system.

<Current Feedback Control Section 62>

The current feedback control section 62 performs feedback control such as PI control that changes a command signal for a voltage to be applied to the electric motor EM to two-phase voltage command signals Vd, Vq expressed in the dq axis rotating coordinate system such that the two-phase currents Id, Iq approach the two-phase target currents Ido, Iqo.

<Alternate Current Voltage Command Calculating Section 63>

The alternate current voltage command calculating section 63 converts the two-phase voltage command signals Vd, Vq to three-phase voltage command signals Vu, Vv, Vw. That is, the alternate current voltage command calculating section 63 performs a fixed coordinate conversion and a two-phase to three-phase conversion based on the magnetic pole position Be to convert the two-phase voltage command signals Vd, Vq expressed in the dq axis rotating coordinate system to the three-phase voltage command signals Vu, Vv, Vw that are voltage command signals to respective coils for three-phase.

<Inverter Control Section 64>

The inverter control section 64 generates inverter control signals for controlling on/off operations of a plurality of switching elements provided in the inverter IN based on the three-phase voltage command signals Vu, Vv, Vw. The inverter control section 64 generates the inverter control signals through various kinds of pulse width modulation (PWM) based on a comparison between the three-phase voltage command signals Vu, Vv, Vw and a carrier wave. The on/off operations of the plurality of switching elements provided in the inverter IN is controlled based on the inverter control signal.

<Position Speed Calculating Section 65>

The position speed calculating section 65 calculates the magnetic pole position Be of the electric motor EM and a rotational speed we of the magnet pole position (rotational speed ωm of the electric motor EM). The rotational speed ωm of the electric motor EM may be detected by a rotational speed detection sensor such as a resolver. However, in the present embodiment, an electric motor EM without sensor that is not provided with a rotational speed detection sensor is utilized.

The position speed calculating section 65 is configured to estimate the magnetic pole position θe and the rotational speed we based on speed electromotive force estimation using an applied voltage and a motor current, or configured to estimate the magnetic pole position Be and the rotational speed we by observing the current and the voltage when harmonic voltage or current is applied using saliency of an Interior Permanent Magnet Synchronous Motor (IPMSM).

3-2-3-2. Rotational Speed Control Section 44

The rotational speed control section 44 is a function section that executes rotational speed control that changes the output torque Tm of the electric motor EM such that the rotational speed ωm of the electric motor EM approaches a target rotational speed ωmo. In the present embodiment, the rotational speed control section 44 is provided with function sections of a speed feedback control section 70 and a target speed setting section 71.

<Target Speed Setting Section 71>

The target speed setting section 71 is a function section that sets the target rotational speed ωmo of the electric motor EM. As the rotational speed ωm of the electric motor EM increases, the discharging amount of oil of the electric oil pump EP increases. The target speed setting section 71 increases the target rotational speed ωmo as a supply amount of oil required to supply to a supply target increases, for example, at a time of a speed change in which the shift speed of the speed change device TM is changed.

<Speed Feedback Control Section 70>

The speed feedback control section 70 is a function section that executes rotational speed control that changes the output torque Tm of the electric motor EM such that the rotational speed ωm of the electric motor EM approaches the target rotational speed ωmo.

In the present embodiment, the speed feedback control section 70 is configured to execute proportional-integral control (PI control) that performs proportion and integration based on a deviation between the target rotational speed ωmo and the rotational speed ωm of the electric motor EM to calculate the target output torque Tmo of the electric motor EM. Control gain (proportional gain, integral gain, in the present example) of the rotational speed control is set such that an overshoot amount, a convergence time, vibratility in target value response that represents response of the rotational speed ωm with respect to a change in the target rotational speed ωmo become adequate.

3-2-3-3. Electromotive Drive Control Section 45

The electromotive drive control section 45 is a function section that executes the electromotive drive control that causes the electric oil pump EP to be driven while the rotation of the internal combustion engine ENG is stopped

In the present embodiment, the electromotive drive control section 45 is configured to execute the electromotive drive control that causes the electric oil pump EP to be driven in a case in which the idling stop condition is satisfied and the rotation of the internal combustion engine ENG is stopped.

In the present embodiment, as described above, the speed change control section 40 is configured to establish a target shift speed in the speed change device TM to enable the vehicle to start immediately after starting the internal combustion engine ENG even in a case in which the idling stop condition is satisfied. Thus, in a case in which the rotation of the internal combustion engine ENG is stopped and the mechanical oil pump MP is not driven, it is necessary to cause the electric oil pump EP to be driven by the electric motor EM and generate hydraulic pressure to be supplied to the speed change device TM.

<Shortage of Supply Amount of Oil Due to Idle Running State>

However, while the electric oil pump EP is driven, in a case in which an idle running state in which air is mixed in a pump chamber accommodating a pump rotor is caused due to some factors, the discharging amount of oil of the electric oil pump EP decreases. Thereby, hydraulic pressure required to establish a shift speed and for lubrication and cooling may not be supplied to the speed change device TM, etc.

The idle running state is caused in the following situation. In a case in which the vehicle is on an up/downhill, in a case in which the vehicle speed suddenly changes, etc., a liquid surface of oil stored in an oil pan changes in relation to a horizontal state when the vehicle is on a horizontal road, thereby a suction port of oil such as a strainer is exposed in air and the electric oil pump EP sucks air. In addition, the idle running state is also caused in the following situation. Driving of the electric oil pump EP is started in a case in which, after the driving of the electric oil pump EP is stopped for a long period of time, oil is drained from the electric oil pump EP and a suction oil passage from the strainer to the electric oil pump EP due to influence of gravity, and air is flown in instead.

The electromotive drive control section 45 is configured to, during execution of the electromotive drive control, in a case in which the idle running state in which air is mixed in the pump chamber of the electric oil pump EP is caused, execute the double pump drive control that starts the rotation of the internal combustion engine ENG to cause the mechanical oil pump MP to be driven and continues the driving of the electric oil pump EP.

In the present embodiment, the electromotive drive control section 45 is configured to transmit a request to cause the rotation of the internal combustion engine ENG and cause the internal combustion engine ENG to be started even in a case in which the idling stop condition is satisfied. Because the mechanical oil pump MP is driven by the rotation of the internal combustion engine ENG, the shortage of the supply amount of oil may be reduced or solved.

In addition, because the driving of the electric oil pump EP continues, the air mixed in the pump chamber is discharged and oil is supplied to the pump chamber. Thereby, the idle running state is solved early. When oil is filled in the pump chamber accommodating the pump rotor and air is discharged from the pump chamber, the idle running state ends.

In addition, even in a case in which the idle running state in which air is mixed in a pump chamber accommodating a pump rotor of the mechanical oil pump MP is caused, it is possible to solve the idle running state earlier than the electric oil pump EP because the discharging amount (discharging capability) of the mechanical oil pump MP according to the present embodiment is greater than the discharging amount (discharging capability) of the electric oil pump ER Therefore, the shortage of the supply amount of oil may be reduced or solved earlier by causing the internal combustion engine ENG to rotate thereby causing the mechanical oil pump to be driven.

The electromotive drive control section 45 is configured to stop the rotation of the internal combustion engine ENG in a case in which the idle running state of the electric oil pump EP ends during execution of the double pump drive control. Note that the driving of the electric oil pump EP continues after the rotation of the internal combustion engine ENG stops.

In the present embodiment, the electromotive drive control section 45 is configured to, during execution of the electromotive drive control, in a case in which the rotational speed ωm of the electric oil pump EP becomes greater than a start determination rotational speed, or in a case in which a magnitude (absolute value) of a rate of change (rotational acceleration) in the rotational speed ωm of the electric oil pump EP becomes greater than the start determination rate of change, start the double pump drive control that starts the rotation of the internal combustion engine ENG to cause the mechanical oil pump MP to be driven and continues the driving of the electric oil pump EP.

The start determination rotational speed is set to a rotational speed that is greater than the rotational speed ωm of the electric oil pump EP when the idle running state is not caused in the electric oil pump ER In addition, the start determination rate of change is set to a magnitude of a rate of change that is greater than the magnitude (absolute value) of the rate of change in the rotational speed ωm of the electric oil pump EP when the idle running state is not caused in the electric oil pump EP

The electromotive drive control section 45 is configured to start the double pump drive control in a case in which the rate of change in the rotational speed corn of the electric oil pump EP during an increase in the rotational speed ωm after starting the driving of the electric oil pump EP is greater than the start determination rate of change at a time of starting pump driving in the electromotive drive control. The start determination rate of change at the time of starting pump driving is set to a rate of change that is greater than the rate of change in the rotational speed ωm of the electric oil pump EP during an increase in the rotational speed ωm after starting the driving of the electric oil pump EP when an idle running state is not caused.

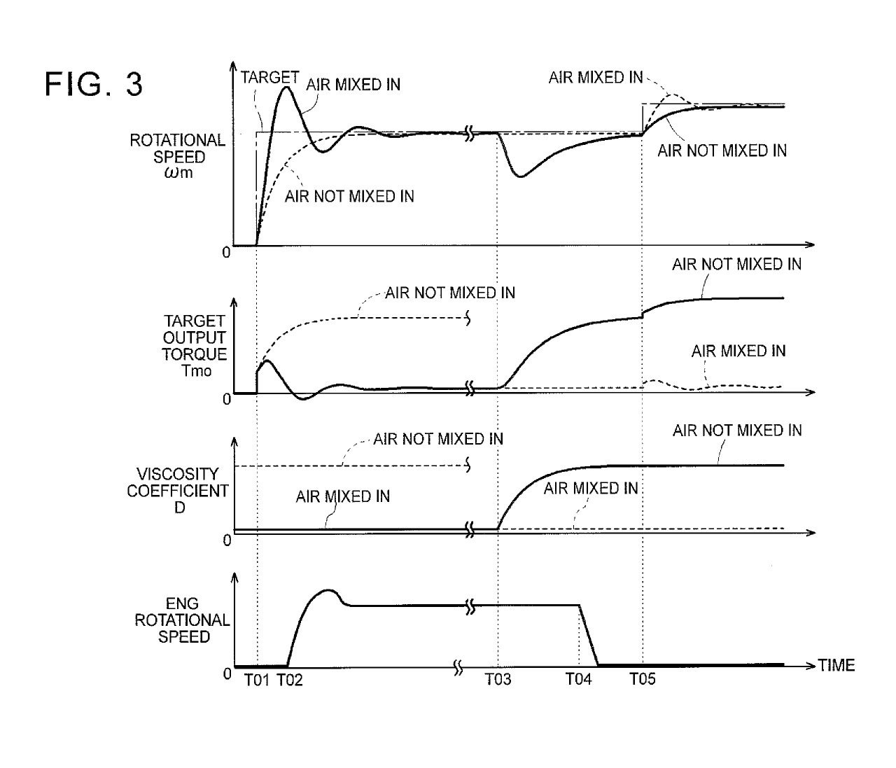

While the driving of the electric oil pump EP is stopped, air may be mixed in the pump chamber or the suction oil passage from the strainer to the pump chamber due to the aforementioned factors. As shown in FIG. 3, in a case in which the driving of the electric oil pump EP is started (subsequent to time T01) in a state in which air is mixed in, a viscosity resistance is small. Therefore, the rate of change in the rotational speed of the electric oil pump EP becomes greater than the rate of change corresponding to a case in which the idle running state is not caused.

In the present embodiment, the control gain of the rotational speed control is set such that the target value response in feedback in the rotational speed in a case in which air is not mixed in becomes the response including an adequate overshoot amount, convergence time, and vibratility. Therefore, in a case in which air is not mixed in, as shown by dashed line in FIG. 3, the driving of the electric oil pump EP is started at time T01, and the target rotational speed is increased in a stepped manner. Thereafter, the rotational speed ωm of the electric oil pump EP (electric motor EM) increases with a delay, and the overshoot amount and vibrability are small.

On the other hand, in a case in which air is mixed in, the viscosity resistance of oil acting on the pump rotor is lowered. When the viscosity resistance is lowered, a magnitude of change in the rotational speed ωm of the electric motor EM with respect to the change in the output torque Tm of the electric motor EM increases. As a result, as shown by solid line in FIG. 3, an increase rate in the rotational speed ωm of the electric motor EM is equal to or greater than an increase rate in a case in which air is not mixed in. The control is performed using the control gain set in accordance with the viscosity resistance in a case in which air is not mixed. Therefore, compared to a case in which air is not mixed in, in the target value response, the vibratility increases at higher frequencies and the overshoot amount with respect to the target rotational speed ωmo increases.

The electromotive drive control section 45 is configured to start the double pump drive control in a case in which the rate of change in the rotational speed ωm of the electric oil pump EP during an increase in the rotational speed win after starting the driving of the electric oil pump EP is greater than the start determination rate of change at the time of starting pump driving, and not to start the double pump drive control in a case in which the rate of change in the rotational speed ωm of the electric oil pump EP during an increase in the rotational speed ωm after starting the driving of the electric oil pump EP is equal to or less than the start determination rate of change at the time of starting pump driving

For example, the electromotive drive control section 45 is configured to, after the driving of the electric oil pump EP starts, measure time-to-reach until the rotational speed ωm of the electric oil pump EP reaches a determination speed (for example, 80% of a target rotational speed ωmo) that is set based on the target rotational speed ωmo, and divide the determination speed by the time-to-reach to acquire the rate of change in the rotational speed ωm of the electric oil pump ER The electromotive drive control section 45 is configured to determine that the idle running state is caused in a case in which the acquired rate of change in the rotational speed ωm is greater than the start determination rate of change (for example, 150% of the rate of change in the rotational speed ωm in a case in which the idle running state is not caused) at the time of starting pump driving that is set in advance in accordance with the rate of change in the rotational speed ωm in a case in which the idle running state is not caused, and start the double pump drive control. In the example shown in FIG. 3, the electromotive drive control section 45 determines at time T02 that the idle running state is caused because the rate of change in the rotational speed ωm is greater than the start determination rate of change and causes the internal combustion engine ENG to be driven to start the rotation.

In addition, in the present embodiment, the electromotive drive control section 45 is configured to, after the driving of the electric oil pump EP starts, in a case in which the rotational speed ωm of the electric oil pump EP reaches the start determination rotational speed at the time of starting the pump driving, determine that the idle running state is caused and start the double pump drive control, and in a case in which the rotational speed ωm of the electric oil pump EP does not reach the start determination rotational speed, determine that the idle running state is not caused and not start the double pump drive control. The start determination rotational speed at the time of starting the pump driving is set to a rotational speed (for example, 120% of the target rotational speed ωmo) that is greater than the target rotational speed ωmo. In addition, the target rotational speed ωmo corresponds to the rotational speed ωm of the electric oil pump EP when the idle running state is not caused in the electric oil pump ER

In addition, in the present embodiment, the electromotive drive control section 45 is configured to, during execution of the electromotive drive control, in a case in which the driving force (output torque Tm) of the electric motor EM decreases to a start determination driving force (output torque) or less, start the double pump drive control. The start determination driving force is set to a driving force that is less than the driving force of the electric motor EM in a case in which the idle running state is not caused in the electric oil pump EP.

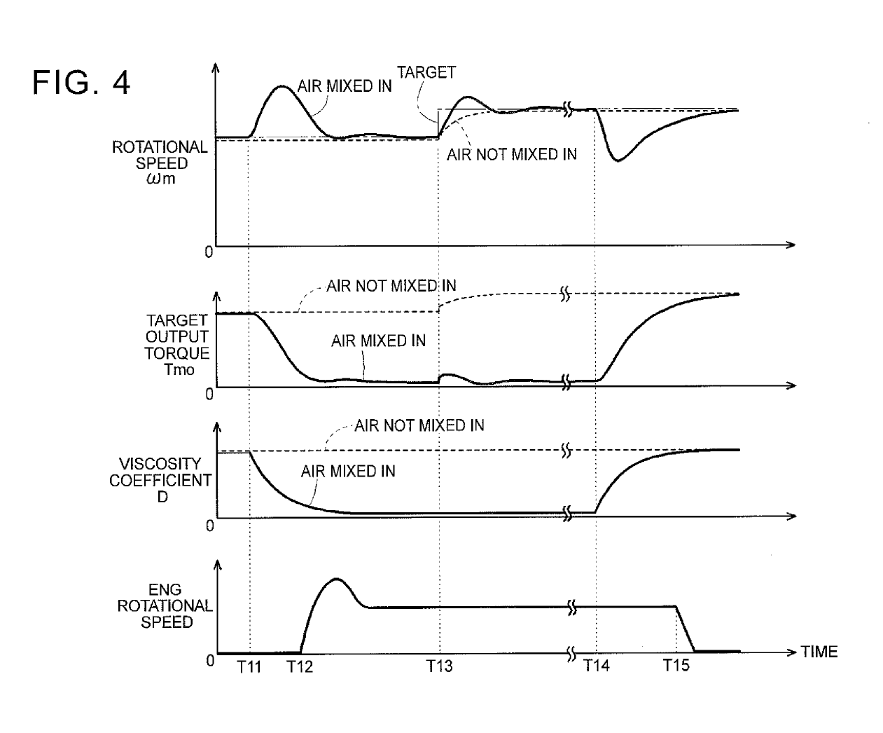

While the electric oil pump EP is driven, air may be mixed in the pump chamber accommodating the pump rotor due to the aforementioned factors. As shown in FIG. 4, in a case in which air is mixed in while the electric oil pump EP is driven (subsequent to time T11), the viscosity resistance of oil acting on the pump rotor decreases. Therefore, the output torque Tm of the electric motor EM necessary to maintain the rotational speed ωm of the electric oil pump EP to be the target rotational speed decreases in accordance with the decrease in the viscosity resistance.

For example, the electromotive drive control section 45 is configured to, in a case in which the output torque Tm (target output torque Tmo) of the electric motor EM becomes less than the start determination driving force (for example, 50% of the output torque Tm in a case in which the idle running state is not caused) that is set in advance in accordance with the output torque Tm (target output torque Tmo) when the idle running state is not caused, determine that the idle running state is caused and start the double pump drive control. In the example shown in FIG. 4, because the target output torque Tmo of the electric motor EM becomes less than the start determination driving force at time T12, the electromotive drive control section 45 determines that the idle running state is caused and causes the internal combustion engine ENG to be driven to start the rotation.

As shown in FIG. 4, during the execution of the electromotive drive control, the rotational speed ωm of the electric oil pump EP overshoots with respect to the target rotational speed ωmo during a time period (from time T11 to time T12) after the idle running state is caused and until the driving force (output torque Tm) of the electric motor EM decreases to the driving force corresponding to the idle running state. The electromotive drive control section 45, as mentioned above, is configured to start the double pump drive control in a case in which the rotational speed ωm of the electric oil pump EP becomes greater than the start determination rotational speed. In the present embodiment, the start determination rotational speed is set to a rotational speed (for example, 120% of the target rotational speed ωmo) that is greater than the target rotational speed wino. The target rotational speed wino corresponds to the rotational speed ωm of the electric oil pump EP in a case in which the idle running state is not caused in the electric oil pump EP.

In addition, as mentioned above, in a case in which air is mixed in, the viscosity resistance of oil acting on the pump rotor decreases. Thereby, the magnitude of change in the rotational speed ωm of the electric oil pump EP with respect to the change in the output torque Tm of the electric motor EM increases, which is easily determined when the target rotational speed ωmo has changed. As shown in FIG. 4, after the target rotational speed ωmo is changed in a stepped manner at time T13, in a case in which air is mixed in, the magnitude of change in the rotational speed ωm of the electric oil pump EP with respect to the change in the target output torque Tmo of the electric motor EM increases and the magnitude of the rate of change in the rotational speed ωm of the electric oil pump EP increases, compared to a case in which air is not mixed in. In addition, in a case in which air is mixed in, in the target value response, the vibratility increases at higher frequencies and the overshoot amount with respect to the target rotational speed ωmo increases, compared to a case in which air is not mixed in.

In the present embodiment, the electromotive drive control section 45 is configured to start the double pump drive control in a case in which the magnitude (absolute value) of the rate of change in the rotational speed ωm of the electric oil pump EP after the target rotational speed ωmo is changed is greater than the start determination rate of change.

The electromotive drive control section 45 is configured to, after changing the target rotational speed coma by a predetermined change amount, measure time-to-reach until a change amount of the rotational speed ωm of the electric oil pump EP reaches a determination change amount (for example, 80% of a change amount of the target rotational speed ωmo) that is set based on the change amount of the target rotational speed ωmo, and divide the determination change amount by the time-to-reach to acquire the rate of change in the rotational speed ωm. The electromotive drive control section 45 is configured to, in a case in which the acquired rate of change in rotational speed ωm is greater than the start determination rate of change (for example, 150% of the rate of change in the rotational speed ωm when the idle running state is not caused), determine that the idle running state is caused and start the double pump drive control.

In a case in which the control gain (control gain of the PI control in the present example) in the rotational speed control of the electric motor EM is changed, the magnitude of the rate of change in the rotational speed ωm of the electric oil pump EP changes even in a same state in which air is mixed in. In a case in which the control gain of the rotational speed control is increased, the magnitude of the rate of change in the driving force of the electric motor EM increases. Therefore, the magnitude of the rate of change in the rotational speed ωm increases in a same state in which air is mixed in. In a case in which the control gain of the rotational speed control is decreased, the magnitude of the rate of change in the driving force of the electric motor EM decreases. Therefore, the magnitude of the rate of change in the rotational speed ωm decreases in a same state in which air is mixed in. Thus, the electromotive drive control section 45 may be configured to change the start determination rate of change in accordance with setting of the control gain of the rotational speed control. The electromotive drive control section 45 decreases the start determination rate of change in a case in which the control gain of the rotational speed control is decreased, and increases the start determination rate of change in a case in which the control gain of the rotational speed control is increased.

In addition, the electromotive drive control section 45 may be configured to start the double pump drive control in a case in which the magnitude of change in the rotational speed ωm of the electric oil pump EP with respect to the change in the driving force (output torque Tm) of the electric motor EM increases to the start determination value or more. In such configuration, it is possible to determine the change in the viscosity resistance because air is mixed in, without being affected by the change in the control gain of the rotational speed control. The start determination value is set to a value greater than the magnitude of change in the rotational speed ωm of the electric oil pump EP with respect to the change in the driving force of the electric motor EM when the idle running state is not caused in the electric oil pump EP.

In such a case, for example, the electromotive drive control section 45 is configured to, after changing the target rotational speed ωmo by a predetermined change amount, integrate an operation amount of the output torque Tm (target output torque Tmo) of the electric motor EM until the change amount of the rotational speed ωm of the electric oil pump EP reaches the determination change amount (for example, 80% of the change amount of the target rotational speed ωmo) that is set based on the change amount of the target rotational speed ωmo, divide the determination change amount by the integrated value of the operation amount, and acquire the magnitude of change in the rotational speed win of the electric oil pump EP with respect to the change in the driving force of the electric motor EM. The electromotive drive control section 45 is configured to, in a case in which the acquired magnitude of change in the rotational speed win is greater than the start determination value (for example, 150% of the magnitude of change in the rotational speed ωm when the idle running state is not caused) that is set in advance in accordance with the magnitude of the change in the rotational speed ωm with respect to the change in the driving force of the electric motor EM when the idle running state is not caused, determine that the idle running state is caused and start the double pump drive control.

<Idle Running State End Determination)

In the present embodiment, the electromotive drive control section 45 is configured to, during execution of the double pump drive control, in a case in which the driving force of the electric motor EM increases to an end determination driving force or more, or in a case in which the magnitude (absolute value) of the rate of change (rotational acceleration) in the rotational speed ωm of the electric oil pump EP decreases to an end determination rate of change, stop the rotation of the internal combustion engine ENG

The end determination driving force is set to a driving force that is less than the driving force of the electric motor EM when the idle running state is not caused in the electric oil pump EP. The end determination rate of change is set to a magnitude of the rate of change greater than the magnitude of the rate of change in the rotational speed ωm of the electric oil pump EP when the idle running state is not caused in the electric oil pump EP. In the present embodiment, the end determination driving force is set to the start determination driving force or more. In addition, the end determination rate of change is set to the start determination rate of change or less.

When the electric oil pump EP continues to be driven, the air mixed in the pump chamber may be discharged, oil may be supplied, and the idle running state may be solved. When air is not mixed in any more, the viscosity resistance increases, thereby the output torque TM of the electric motor EM necessary to maintain the rotational speed ωm of the electric oil pump EP to be the target rotational speed increases in accordance with an increase in the viscosity resistance.

For example, the electromotive drive control section 45 is configured to, in a case in which the output torque Tm (target output torque Tmo) of the electric motor EM is greater than the end determination driving force (for example, 80% of the output torque Tm when the idle running state is not caused) that is set in advance in accordance with the output torque Tm (target output torque Tmo) when the idle running state is not caused, determine that the idle running state has ended and stop the rotation of the internal combustion engine ENG. In the examples shown in FIGS. 3 and 4, the electromotive drive control section 45 determines that the idle running state has ended and stops the rotation of the internal combustion engine ENG because the target output torque Tmo of the electric motor EM is greater than the end determination driving force at time T04 and time T15.

In addition, as mentioned above, when air is not mixed in any more, the viscosity resistance of oil acting on the pump rotor increases, thereby the magnitude of change in the rotational speed ωm of the electric oil pump EP with respect to the change in the output torque Tm of the electric motor EM decreases, which is easily determined when the target rotational speed ωmo is changed. As shown in FIG. 3, after the target rotational speed ωmo is changed in a stepped manner at time T05, in a case in which air is not mixed in, the magnitude of change in the rotational speed ωm of the electric oil pump EP with respect to the change in the target output torque Tmo of the electric motor EM decreases and the magnitude of the rate of change in the rotational speed ωm of the electric oil pump EP decreases, compared to a case in which air is mixed in. In addition, because air is not mixed in any more, in the target value response, the vibratility decreases at lower frequencies and the overshoot amount with respect to the target rotational speed ωmo decreases, compared to a case in which air is mixed in.

For example, the electromotive drive control section 45 is configured to, after changing the target rotational speed ωmo by a predetermined change amount, measure time-to-reach until the change amount of the rotational speed ωm of the electric oil pump EP reaches the determination change amount (for example, 80% of the change amount of the target rotational speed) that is set based on the change amount of the target rotational speed, and divide the determination change amount by the time-to-reach to acquire the rate of change in the rotational speed ωm. The electromotive drive control section 45 is configured to, in a case in which the acquired rate of change in the rotational speed ωm is less than the end determination rate of change (for example, 150% of the magnitude of the rate of change in the rotational speed ωm when the idle running state is not caused) that is set in advance in accordance with the magnitude of the rate of change in the rotational speed ωm when the idle running state is not caused, determine that the idle running state has ended and stop the rotation of the internal combustion engine ENG.

As mentioned above, in a case in which the control gain of the rotational speed control is changed, the magnitude of the rate of change in the rotational speed ωm of the electric oil pump EP changes even in a same state in which air is mixed in. The electromotive drive control section 45 may be configured to change the end determination rate of change in accordance with setting of the control gain of the rotational speed control. The electromotive drive control section 45 decreases the end determination rate of change in a case in which the control gain of the rotational speed control is decreased, and increases the end determination rate of change in a case in which the control gain of the rotational speed control is increased.

In addition, the electromotive drive control section 45 may be configured to stop the rotation of the internal combustion engine ENG in a case in which the magnitude of change in the rotational speed ωm of the electric oil pump EP with respect to the change in the driving force (output torque Tm) of the electric motor EM decreases to the end determination value or less. In such configuration, it is possible to determine the change in the viscosity resistance because air is mixed in, without being affected by the change in the control gain of the rotational speed control. The end determination value is set to a value greater than the magnitude of change in the rotational speed ωm of the electric oil pump EP with respect to the change in the driving force of the electric motor EM when the idle running state is not caused in the electric oil pump EP.

In such a case, for example, the electromotive drive control section 45 is configured to, after changing the target rotational speed ωmo by a predetermined change amount, integrate an operation amount of the output torque Tm (target output torque Tmo) of the electric motor EM until the change amount of the rotational speed ωm of the electric oil pump EP reaches the determination change amount (for example, 80% of the change amount of the target rotational speed ωmo) that is set based on the change amount of the target rotational speed ωmo, divide the determination change amount by the integrated value of the operation amount, and acquire the magnitude of change in the rotational speed ωm of the electric oil pump EP with respect to the change in the driving force of the electric motor EM. The electromotive drive control section 45 is configured to, in a case in which the acquired magnitude of change in the rotational speed ωm is greater than the end determination value (for example, 150% of the magnitude of change in the rotational speed ωm when the idle running state is not caused) that is set in advance in accordance with the magnitude of change in the rotational speed ωm of the electric oil pump EP with respect to the change in the driving force of the electric motor EM when the idle running state is not caused, determine that the idle running state has ended and stop the rotation of the internal combustion engine ENG.

As shown in FIG. 4, during the execution of the electromotive drive control, after the idle running state starts to be solved until the driving force (output torque Tm) of the electric motor EM increases to the driving force corresponding to the idle running state (time T14 to time T15), the rotational speed ωm of the electric oil pump EP undershoots with respect to the target rotational speed ωmo. The electromotive drive control section 45 may be configured to stop the rotation of the internal combustion engine ENG in a case in which the rotational speed ωm of the electric oil pump EP becomes less than the end determination rotational speed. The end determination rotational speed is set to a rotational speed that is less than the rotational speed ωm of the electric oil pump EP when the idle running state is not caused in the electric oil pump EP. The end determination rotational speed is set to a rotational speed (for example 80% of the target rotational speed ωmo) that is less than the target rotational speed ωmo. The target rotational speed ωmo corresponds to the rotational speed ωm of the electric oil pump EP when the idle running state is not caused in the electric oil pump EP.

3-2-3-4. Flowchart

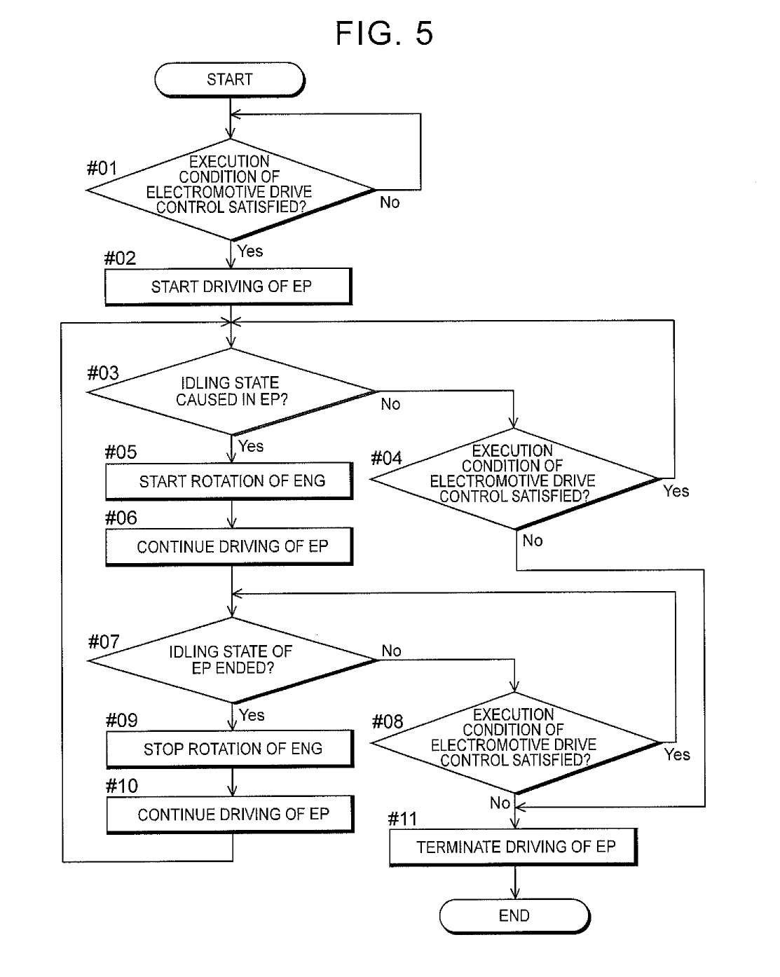

Based on a flowchart shown in FIG. 5, a process of the electromotive drive control is explained.

The electromotive drive control section 45, in a case in which an execution condition of the electromotive drive control is satisfied (Step #01: Yes), starts the electromotive drive control that causes the electric oil pump EP to be driven while the rotation of the internal combustion engine ENG is stopped. The execution condition of the electromotive drive control is satisfied in a case in which hydraulic pressure is supplied to the vehicular drive device 2 in order to cause the vehicular drive device 2 to be capable of transmitting motive power in a state in which the rotation of the internal combustion engine ENG is stopped. The execution condition of the electromotive drive control is not satisfied in a case in which hydraulic pressure is not supplied. In the present embodiment, the execution condition of the electromotive drive control is satisfied in order to establish a shift speed in the speed change device TM in a case in which the idling stop condition is satisfied.

The electromotive drive control section 45 starts the driving of the electric oil pump EP (Step #02). Specifically, the electromotive drive control section 45 starts the rotation of the electric motor EM by causing the rotational speed control section 44 to start the rotational speed control.

The electromotive drive control section 45 determines whether the idle running state in which air is mixed in the pump chamber of the electric oil pump EP is caused during the execution of the electromotive drive control (Step 403). In the present embodiment, as mentioned above, the electromotive drive control section 45 is configured to determine that the idle running state is caused in a case in which the rotational speed ωm of the electric oil pump EP becomes greater than the start determination rotational speed, in a ease in which the magnitude of the rate of change in the rotational speed ωm of the electric oil pump EP becomes greater than the start determination rate of change, in a case in which the driving force of the electric motor EM decreases to the start determination driving force or less, and the like. The electromotive drive control section 45, in a case in which the idle running state is caused in the electric oil pump EP (Step #03: Yes), executes the double pump drive control that starts the rotation of the internal combustion engine ENG to cause the mechanical oil pump MP to be driven (Step #05) and continues the driving of the electric oil pump EP (Step #06).

On the other hand, the electromotive drive control section 45 maintains the rotation of the internal combustion engine ENG to be stopped and the electric oil pump EP to be driven in a case in which the idle running state is not caused in the electric oil pump EP (Step #03: No) and the execution condition of the electromotive drive control remains satisfied (Step #04: Yes).

The electromotive drive control section 45 determines whether the idle running state in the electric oil pump EP has ended during the execution of the double pump drive control (Step #07). In the present embodiment, as mentioned above, the electromotive drive control section 45 is configured to determine that the idle running state has ended in a case in which the driving force of the electric motor EM increases to the end determination driving force or more, in a case in which the magnitude of the rate of change in the rotational speed ωm of the electric oil pump EP decreases to the end determination rate of change or less, and the like. The electromotive drive control section 45, in a case in which the idle running state in the electric oil pump EP has ended (Step #07: Yes), stops the rotation of the internal combustion engine ENG (Step #09) and continues the driving of the electric oil pump EP (Step #10). The electromotive drive control section 45 returns to Step #03 and determines whether the idle running state is caused in the electric oil pump EP again.

On the other hand, the electromotive drive control section 45, in a ease in which the idle running state in the electric oil pump EP does not end (Step #07: No) and the execution condition of the electromotive drive control remains satisfied (Step #08: Yes), continues the double pump drive control and maintains the rotation of the internal combustion engine ENG and the driving of the electric oil pump EP.

The electromotive drive control section 45, during the execution of the electromotive drive control, in a case in which the execution condition of the electromotive drive control is not satisfied any more (Step #04: No, or Step #08: No), terminates the driving of the electric oil pump EP (Step #11) and terminates the electromotive drive control. The execution condition of the electromotive drive control is not satisfied any more in a case in which oil supply from the electric oil pump EP to the vehicular drive device 2 becomes unnecessary. In the present embodiment, in a case in which the idling stop condition is not satisfied any more, the execution condition of the electromotive drive control is not satisfied any more. For example, in a case in which the shift position is set to the drive range and the braking pedal is not depressed, the idling stop condition is not satisfied any more and the driving of the electric oil pump EP is terminated. In such a case, the rotation of the internal combustion engine ENG is started. Therefore, the mechanical oil pump MP is caused to be driven.

### OTHER EMBODIMENTS

Lastly, other embodiments of the present disclosure are explained. A configuration disclosed in each of the embodiments described below is not limited to be applied separately. The configuration may be applied in combination with a configuration disclosed in any other embodiment unless any contradiction occurs.

(1) In the embodiment described above, a case is exemplified, in which only the internal combustion engine ENG is provided as the driving force source of the vehicle. However, embodiments of the present disclosure are not limited thereto. That is, as the driving force source of the vehicle, in addition to the internal combustion engine ENG, an electric motor for driving wheels having both functions of an electric motor and an electric generator may be provided. In such a case, for example, the electric motor for driving wheels may be coupled to the speed change input shaft M or the output shaft O so as to rotate together. Alternatively, the electric motor for driving wheels may be drivingly coupled to wheels different from wheels W driven by the internal combustion engine ENG. In such a case, the electromotive drive control section 45 may be configured to, in order to supply oil to the speed change device TM, the electric motor for driving wheels, etc., execute the electromotive drive control that causes the electric oil pump EP to be driven also in a case in which an electric travel mode that causes the wheels to be driven by the driving force of the electric motor for driving wheels is executed in a state in which the rotation of the internal combustion engine ENG is stopped, in addition to a state in which the idling stop is in operation.

Alternatively, the electric motor for driving wheels may be coupled to the input shaft I so as to rotate together. In such a case, a clutch may be provided on a power transmission path between the internal combustion engine ENG and the rotary electric machine.

(2) In the aforementioned embodiment, an example is explained, in which the torque converter 14 and the speed change device TM are provided in the vehicular drive device 2. However, embodiments of the present disclosure are not limited thereto. That is, any configuration may be applied to the vehicular drive device 2 as long as a target to supply hydraulic pressure of the vehicular hydraulic pressure supply device 1 is provided. For example, a continuously variable transmission may be provided as the speed change device TM, the torque converter 14 may not be provided, and a clutch, a differential gear mechanism, etc. may be provided on the power transmission path.

(3) In the aforementioned embodiment, a case is explained as an example, in which the control device 30 is provided with a plurality of function sections 40 to 45. However, embodiments of the present disclosure are not limited thereto. That is, the control device 30 may be provided with a plurality of control units and the plurality of control units may be provided with the plurality of function sections 40 to 45 by sharing the plurality of function sections 40 to 45.

(4) In the aforementioned embodiment, a case is explained as an example, in which the rotational speed control of the electric motor EM is constituted of proportional-integral control. However, embodiments of the present disclosure are not limited thereto. Any control may be utilized as long as the output torque of the electric motor is changed by the control such that the rotational speed ωm of the electric motor EM approaches the target rotational speed ωmo.

(5) In the aforementioned embodiment, a case is explained as an example, in which the electromotive drive control section 45 is configured to execute a plurality of methods to determine the idle running state in the electric oil pump ER However, embodiments of the present disclosure are not limited thereto. The electromotive drive control section 45 may be configured to execute one method or a plurality of methods in any combination among the plurality of methods to determine the idle running state.

(6) In the aforementioned embodiment, a case is explained as an example, in which the gear pump and the vane pump provided with the pump rotor are utilized as the electric oil pump EP and the mechanical oil pump MP. However, embodiments of the present disclosure are not limited thereto. As the electric oil pump EP and the mechanical oil pump MP, any kinds of oil pumps may be utilized as long as the oil pumps have a function that sucks and discharges oil. For example, a piston pump in a swash plate type, etc. may be utilized. In such a case, inside a cylinder serves as the pump chamber and the idle running state is a state in which air is mixed in the cylinder.

### INDUSTRIAL APPLICABILITY

The present disclosure may be suitably applied to a control device that controls a vehicular hydraulic pressure supply device provided with a mechanical oil pump that is driven by an internal combustion engine, an electric oil pump that is driven by an electric motor, an oil passage that supplies oil discharged from the mechanical oil pump and the electric oil pump to a supply target.

1. A control device for a vehicular hydraulic pressure supply device that controls the vehicular hydraulic pressure supply device provided with a mechanical oil pump that is driven by an internal combustion engine, an electric oil pump that is driven by an electric motor, and an oil passage that supplies oil discharged from the mechanical oil pump and the electric oil pump to a supply target, the control device comprising:
a controller that is configured to execute electromotive drive control that causes the electric oil pump to be driven while rotation of the internal combustion engine is stopped,
wherein during execution of the electromotive drive control, in a case in which a rotational speed of the electric oil pump becomes greater than a start determination rotational speed, or in a case in which a magnitude of a rate of change in the rotational speed of the electric oil pump becomes greater than a start determination rate of change, the controller starts double pump drive control that starts the rotation of the internal combustion engine to cause the mechanical oil pump to be driven and continues driving of the electric oil pump.

2. The control device for the vehicular hydraulic pressure supply device according to claim 1, wherein the start determination rotational speed is set to a rotational speed that is greater than a target rotational speed of the electric oil pump that performs rotational speed control.

3. The control device for the vehicular hydraulic pressure supply device according to claim 1, wherein the start determination rotational speed is set to a rotational speed that is greater than the rotational speed of the electric oil pump when an idle running state is not caused in the electric oil pump, and
the start determination rate of change is set to a magnitude of a rate of change that is greater than the magnitude of the rate of change in the rotational speed of the electric oil pump when the idle running state is not caused in the electric oil pump.

4. The control device for the vehicular hydraulic pressure supply device according to claim 1, wherein, in the electromotive drive control, in a case in which the rate of change in the rotational speed of the electric oil pump during an increase in the rotational speed after the electric oil pump starts to be driven is greater than the start determination rate of change, the controller starts the double pump drive control.

5. The control device for the vehicular hydraulic pressure supply device according to claim 1, during execution of the double pump drive control, in a case in which a driving force of the electric motor increases to an end determination driving force or more, or in a case in which the magnitude of the rate of change in the rotational speed of the electric oil pump decreases to an end determination rate of change or less, the control controller stops the rotation of the internal combustion engine.

6. The control device for the vehicular hydraulic pressure supply device according to claim 5, wherein
the end determination driving force is set to a driving force that is less than a driving force of the electric motor when an idle running state is not caused in the electric oil pump, and
the end determination rate of change is set to a magnitude of a rate of change that is greater than the magnitude of the rate of change in the rotational speed of the electric oil pump when the idle running state is not caused in the electric oil pump.

7. The control device for the vehicular hydraulic pressure supply device according to claim 1, wherein, during execution of the electromotive drive control, in a case in which a driving force of the electric motor decreases to a start determination driving force or less, the controller starts the double pump drive control.

8. The control device for the vehicular hydraulic pressure supply device according to claim 2, wherein the start determination rotational speed is set to a rotational speed that is greater than the rotational speed of the electric oil pump when an idle running state is not caused in the electric oil pump, and
the start determination rate of change is set to a magnitude of a rate of change that is greater than the magnitude of the rate of change in the rotational speed of the electric oil pump when the idle running state is not caused in the electric oil pump.

9. The control device for the vehicular hydraulic pressure supply device according to claim 2, wherein, in the electromotive drive control, in a case in which the rate of change in the rotational speed of the electric oil pump during an increase in the rotational speed after the electric oil pump starts to be driven is greater than the start determination rate of change, the controller starts the double pump drive control.

10. The control device for the vehicular hydraulic pressure supply device according to claim 2, during execution of the double pump drive control, in a case in which a driving force of the electric motor increases to an end determination driving force or more, or in a case in which the magnitude of the rate of change in the rotational speed of the electric oil pump decreases to an end determination rate of change or less, the controller stops the rotation of the internal combustion engine.

11. The control device for the vehicular hydraulic pressure supply device according to claim 10, wherein
the end determination driving force is set to a driving force that is less than a driving force of the electric motor when an idle running state is not caused in the electric oil pump, and
the end determination rate of change is set to a magnitude of a rate of change that is greater than the magnitude of the rate of change in the rotational speed of the electric oil pump when the idle running state is not caused in the electric oil pump.

12. The control device for the vehicular hydraulic pressure supply device according to claim 2, wherein, during execution of the electromotive drive control, in a case in which a driving force of the electric motor decreases to a start determination driving force or less, the controller starts the double pump drive control.

13. The control device for the vehicular hydraulic pressure supply device according to claim 3, wherein, in the electromotive drive control, in a case in which the rate of change in the rotational speed of the electric oil pump during an increase in the rotational speed after the electric oil pump starts to be driven is greater than the start determination rate of change, the controller starts the double pump drive control.

14. The control device for the vehicular hydraulic pressure supply device according to claim 13, during execution of the double pump drive control, in a case in which a driving force of the electric motor increases to an end determination driving force or more, or in a case in which the magnitude of the rate of change in the rotational speed of the electric oil pump decreases to an end determination rate of change or less, the controller stops the rotation of the internal combustion engine.

15. The control device for the vehicular hydraulic pressure supply device according to claim 14, wherein
the end determination driving force is set to a driving force that is less than a driving force of the electric motor when an idle running state is not caused in the electric oil pump, and
the end determination rate of change is set to a magnitude of a rate of change that is greater than the magnitude of the rate of change in the rotational speed of the electric oil pump when the idle running state is not caused in the electric oil pump.

16. The control device for the vehicular hydraulic pressure supply device according to claim 13, wherein, during execution of the electromotive drive control, in a case in which a driving force of the electric motor decreases to a start determination driving force or less, the controller starts the double pump drive control.

17. The control device for the vehicular hydraulic pressure supply device according to claim 3, during execution of the double pump drive control, in a case in which a driving force of the electric motor increases to an end determination driving force or more, or in a case in which the magnitude of the rate of change in the rotational speed of the electric oil pump decreases to an end determination rate of change or less, the controller stops the rotation of the internal combustion engine.

18. The control device for the vehicular hydraulic pressure supply device according to claim 17, wherein
the end determination driving force is set to a driving force that is less than a driving force of the electric motor when an idle running state is not caused in the electric oil pump, and
the end determination rate of change is set to a magnitude of a rate of change that is greater than the magnitude of the rate of change in the rotational speed of the electric oil pump when the idle running state is not caused in the electric oil pump.

19. The control device for the vehicular hydraulic pressure supply device according to claim 3, wherein, during execution of the electromotive drive control, in a case in which a driving force of the electric motor decreases to a start determination driving force or less, the controller starts the double pump drive control.

20. The control device for the vehicular hydraulic pressure supply device according to claim 4, during execution of the double pump drive control, in a case in which a driving force of the electric motor increases to an end determination driving force or more, or in a case in which the magnitude of the rate of change in the rotational speed of the electric oil pump decreases to an end determination rate of change or less, the controller stops the rotation of the internal combustion engine.
